(19) United States
(12) Patent Application Publication
(10) Pub. No.: US 2026/0336069 A1
(43) Pub. Date: Oct. 29, 2026

(54) Beam Clamp Wrench Device

(71) Applicant: Nicolas Lamancusa, Comstock Park, MI (US)

(72) Inventor: Nicolas Lamancusa, Comstock Park, MI (US)

(21) Appl. No.: 19/391,201

(22) Filed: Nov. 17, 2025

Related U.S. Application Data
(60) Provisional application No. 63/793,865, filed on Apr. 24, 2025.

(51) Int. Cl. B25B 13/46; B25B 13/48; B25B 23/00

(52) U.S. Cl. CPC B25B 13/462; B25B 13/481; B25B 23/0028

(57) ABSTRACT

A beam clamp wrench device is provided. The device is comprised of a wrench device configured to streamline the installation of beam clamps used in structural, electrical, and mechanical systems. The device comprises a body having a first end and a second end, wherein each end is equipped with a ratcheting socket head. The ratcheting socket head at the first end is configured to interface with square-headed bolts, and the ratcheting socket head at the second end is configured to interface with hexagonal lock nuts. A directional switch may be operably connected to each ratcheting head, enabling selection between clockwise and counterclockwise engagement. In one embodiment, each head is pivotally connected to the body via a pin joint or similar hinge mechanism to accommodate non-linear installation angles. The body may include a grip area that may be textured with high-friction patterns to enhance user control.

### CROSS-REFERENCE TO RELATED APPLICATION

The present application claims priority to, and the benefit of, U.S. Provisional Application No. 63/793,865, which was filed on Apr. 24, 2025, and is incorporated herein by reference in its entirety.

### FIELD OF THE INVENTION

The present invention relates generally to the field of wrenches. More specifically, the present invention relates to a dual-ended wrench configured to streamline beam clamp installation by enabling engagement with both square-headed bolts and hexagonal lock nuts using integrated ratcheting socket heads. Accordingly, the present disclosure makes specific reference thereto. Nonetheless, it is to be appreciated that aspects of the present invention are also equally applicable to other like applications, devices, and methods of manufacture.

### BACKGROUND

The installation of beam clamps in construction environments presents persistent challenges related to tool accessibility, safety, and efficiency. Beam clamps are frequently used to secure structural, electrical, or mechanical components in overhead configurations, which often require the installer to work from a ladder or aerial lift. In these elevated or confined positions, switching between tools such as wrenches and pliers is not only inefficient but also introduces safety hazards due to the potential for dropped tools and unstable positioning. Furthermore, conventional tools may not fit easily within the tight spatial constraints typically found near ceilings, especially when fasteners are positioned at awkward angles. This can result in imprecise torque application, where bolts or lock nuts may be under-tightened or over-tightened, thereby compromising the integrity of the installation. Inconsistent fastener engagement further contributes to worker fatigue, as multiple adjustments and repositioning are often required. The absence of a specialized tool that consolidates multiple functions into a single, ergonomic form has led to prolonged installation times and increased physical strain. These issues are compounded across repetitive tasks, highlighting the need for a purpose-built device tailored to the specific geometry and workflow of beam clamp installations.

Therefore, there exists a long-felt need in the art for a beam clamp wrench device that enables users to tighten both square-headed bolts and hexagonal lock nuts without switching tools. There also exists a long-felt need in the art for a beam clamp wrench device that facilitates torque application in restricted or overhead workspaces. Moreover, there exists a long-felt need in the art for a beam clamp wrench device that reduces the risk of tool drops and operator fatigue during elevated installations.

The subject matter disclosed and claimed herein, in one embodiment thereof, comprises a beam clamp wrench device. The device is comprised of a wrench device configured to streamline the installation of beam clamps used in structural, electrical, and mechanical systems. The device comprises a body having a first end and a second end, wherein each end is equipped with a ratcheting socket head. The ratcheting socket head at the first end is configured to interface with square-headed bolts, and the ratcheting socket head at the second end is configured to interface with hexagonal lock nuts. A directional switch may be operably connected to each ratcheting head, enabling selection between clockwise and counterclockwise engagement. In one embodiment, each head is pivotally connected to the body via a pin joint or similar hinge mechanism to accommodate non-linear installation angles. The body may include a grip area that may be textured with high-friction patterns to enhance user control.

In this manner, the beam clamp wrench device of the present invention accomplishes all the foregoing objectives and provides a wrench with a dual-ended ratcheting configuration that eliminates the need for multiple tools during beam clamp installation. More specifically, the specific geometries of the socket heads enable effective engagement with both square-headed bolts and hexagonal lock nuts, ensuring proper torque transfer and minimizing the risk of fastener damage. The ratcheting mechanisms and directional switches facilitate unidirectional torque application, allowing efficient use in restricted spaces. The inclusion of pivoting heads and ergonomic grip surfaces further enhances usability in non-linear and elevated conditions. Collectively, these features address the long-standing inefficiencies, safety risks, and ergonomic challenges associated with traditional beam clamp installation methods, offering a specialized tool that improves speed, precision, and user comfort across various construction trades.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a beam clamp wrench device. The device is designed to streamline the installation and adjustment of beam clamps commonly used in structural steelwork, electrical conduit suspension, HVAC ducting, and pipe support systems. The device engages both a square-headed adjustment bolt and a hexagonal lock nut without requiring tool changes, improving efficiency, safety, and ergonomics, especially in overhead or confined spaces.

The device is comprised of a body with opposing first and second ends, each end comprising a ratcheting socket head. The socket head at the first end is configured to interface with square-headed bolts, and the socket head at the second end is configured to interface with hexagonal lock nuts. Each ratcheting head comprises a cutout configured to engage fasteners of specific geometries. The first head includes a square-profiled cutout with four flat interior surfaces arranged at right angles and chamfered or radiused corners to accommodate tolerances and reduce stress during torque application. The second head includes a 12-point socket cutout arranged in a dual-hexagonal configuration to engage hexagonal lock nuts with reduced risk of rounding edges. In some embodiments, both heads are comprised of 12-point cutouts compatible with both square and hexagonal fasteners.

Each ratcheting head includes an internal mechanism that facilitates unidirectional torque transfer. A directional switch is provided on each head to control the engagement direction of the internal mechanism. Each ratcheting head is pivotally connected to the body via a pivot point, allowing angular deflection. This articulation enables the device to engage fasteners at non-linear or obstructed angles.

A method of use is also disclosed. The method includes providing the device, positioning a respective head over a square-headed bolt or a hexagonal lock nut, actuating the directional switch to select torque direction, applying rotational force to perform adjustment or installation, and pivoting the head as necessary to accommodate obstructed fastener positions.

Accordingly, the beam clamp wrench device of the present invention is particularly advantageous as it provides a wrench with a dual-ended ratcheting configuration that eliminates the need for multiple tools during beam clamp installation. More specifically, the specific geometries of the socket heads enable effective engagement with both square-headed bolts and hexagonal lock nuts, ensuring proper torque transfer and minimizing the risk of fastener damage. The ratcheting mechanisms and directional switches facilitate unidirectional torque application, allowing efficient use in restricted spaces. The inclusion of pivoting heads and ergonomic grip surfaces further enhances usability in non-linear and elevated conditions. Collectively, these features address and overcome the long-standing inefficiencies, safety risks, and ergonomic challenges associated with traditional beam clamp installation methods and tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a beam clamp wrench device of the present invention in accordance with the disclosed architecture;

FIG. 2 illustrates a perspective view of one potential embodiment of a beam clamp wrench device of the present invention in accordance with the disclosed architecture; and

FIG. 3 illustrates a flowchart of a method of using one potential embodiment of a beam clamp wrench device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a beam clamp wrench device that enables users to tighten both square-headed bolts and hexagonal lock nuts without switching tools. There also exists a long-felt need in the art for a beam clamp wrench device that facilitates torque application in restricted or overhead workspaces. Moreover, there exists a long-felt need in the art for a beam clamp wrench device that reduces the risk of tool drops and operator fatigue during elevated installations.

The present invention, in one exemplary embodiment, is comprised of a beam clamp wrench device. The installation and adjustment of beam clamps commonly used in structural steelwork, electrical conduit suspension, HVAC ducting, and pipe support systems are streamlined by the device. By engaging both a square-headed adjustment bolt and a hexagonal lock nut without requiring tool changes, the device enhances operational efficiency, improves safety, and promotes ergonomic use, particularly in overhead or confined environments.

The device is comprised of a body featuring first and second opposing ends, with each end comprising a ratcheting socket head. The ratcheting socket head at the first end is configured to engage square-headed bolts, while the socket head at the second end is configured to engage hexagonal lock nuts. Each ratcheting head comprises a cutout designed to interface with fasteners of specific geometries. The first head includes a square-profiled cutout with four flat internal surfaces positioned at right angles and chamfered or radiused corners to accommodate manufacturing tolerances and reduce stress during torque application. The second head includes a 12-point socket cutout arranged in a dual-hexagonal configuration to engage hexagonal lock nuts with reduced risk of edge rounding. In some configurations, both heads are comprised of 12-point cutouts capable of engaging both square and hexagonal fasteners.

An internal mechanism within each ratcheting head enables unidirectional torque transfer. A directional switch on each head is provided to control the torque engagement direction. Each head is pivotally mounted to the body via a pivot point, allowing for angular deflection and enabling engagement of fasteners located at non-linear or obstructed positions.

A method of use is also disclosed. The method includes providing the device, positioning one of the ratcheting heads over a square-headed bolt or hexagonal lock nut, actuating the directional switch to select the torque direction, applying rotational force to adjust or install the fastener, and pivoting the head as needed to access obstructed fastener positions.

As a result, the device provides a dual-ended ratcheting configuration that eliminates the need for multiple tools during beam clamp installation. The socket geometries further allow for secure engagement with square-headed bolts and hexagonal lock nuts, ensuring reliable torque transfer and reducing the likelihood of fastener damage. The ratcheting mechanisms and directional switches enable effective unidirectional torque application in space-constrained environments. Additionally, the pivoting socket heads and ergonomic grip features enhance usability under non-linear or elevated working conditions. Therefore, the device addresses the long-standing issues related to inefficiency, safety, and ergonomics encountered in traditional beam clamp installation methods and tools.

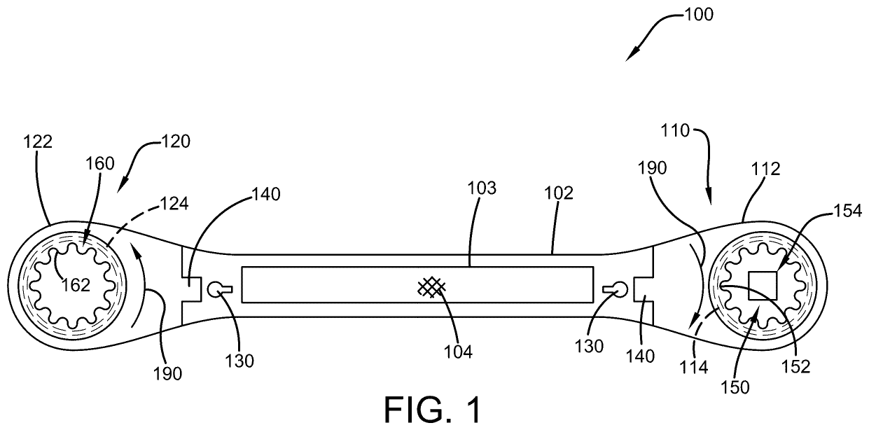

Referring initially to the drawings, FIG. 1 illustrates a top view of one potential embodiment of a beam clamp wrench device 100 of the present invention in accordance with the disclosed architecture. The device 100 is designed to streamline the process of installing and adjusting beam clamps that are frequently utilized in construction trades including but not limited to structural steelwork, electrical conduit suspension, HVAC ducting, and pipe support systems. Said beam clamps typically comprise a square-headed adjustment bolt and a hexagonal lock nut, which conventionally require engagement from separate tools during installation or realignment. The device 100 is configured to engage both fasteners without requiring tool changes, thereby enabling quicker, safer, and more ergonomic field operation, particularly in overhead or confined environments.

The device 100 is comprised of a body 102 having a first end 110 and a second end 120 opposite the first end 110. Each of the first end 110 and the second end 120 may be comprised of a ratcheting socket head 112,122, respectively. In one embodiment, the head 112 of the first end 110 may be sized and configured to interface with square-headed bolts found on beam clamps, while the head 122 of the second end 120 may be sized and configured to interface with hexagonal lock nuts of beam clamps.

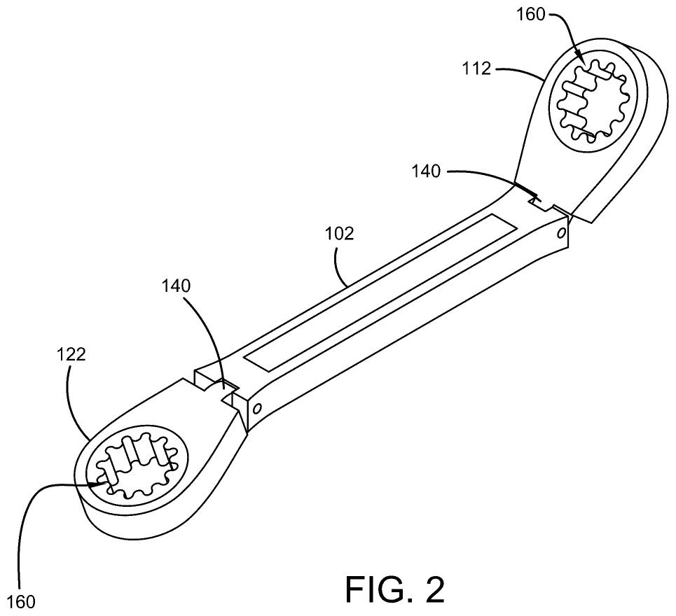

Each ratcheting head 112 and 122 may be comprised of a cutout 150,160 configured to engage the fastener heads of corresponding geometry as noted above. The first head 112 may be comprised of a square-profiled cutout 150 that defines four flat interior surfaces 152 arranged at 90-degree intervals (as seen in FIG. 1) that mate with the corresponding flat faces of a square-headed adjustment bolt. The corners 154 of the cutout 150 may be chamfered or radiused to accommodate manufacturing tolerances and reduce stress concentrations during torque transfer. The second head 122 may be comprised of a 12-point socket cutout 160, as seen in FIG. 1, which defines twelve internal contact surfaces 162 arranged in a dual-hexagonal (double-hex) configuration. This geometry may also be adapted to engage standard hexagonal lock nuts by contacting the nut across twelve points of contact, thereby reducing the likelihood of rounding fastener edges. In some embodiments, both socket heads 112,122 may be comprised of 12-point socket cutouts 160 (as seen in FIG. 2) that are each configured to engage both square-headed bolts and hexagonal nuts.

Each ratcheting head 112,122 may be comprised of an internal mechanism 114,124 that facilitates unidirectional torque transfer. The internal mechanism 114,124 may be comprised of but not limited to any combination of a central drive gear and a spring-loaded pawl engaged with the drive gear. When rotational force is applied in the drive direction of the head 112,122, the spring-loaded pawl locks against the teeth of the drive gear, transmitting torque directly to the engaged fastener within the cutout 150,160. When rotational force is applied in the opposite direction, the pawl is cammed out of engagement with the gear teeth, allowing the body 102 to rotate freely relative to the stationary fastener. This ratcheting configuration enables repetitive back-and-forth movement in spatially restricted environments where full handle rotation is impractical or impossible.

In one embodiment, a directional switch 130 (as seen in FIG. 1) may be provided on each head 112 and 122 to control the engagement direction of the internal mechanism 114,124. The switch 130 may be comprised of but not limited to a sliding cam or a rotating cam that repositions the spring-loaded pawl relative to the gear, thereby selecting either clockwise or counterclockwise torque engagement. In another embodiment, the mechanism 114,124 may be configured to rotate in a first direction when engaging a fastener while the device 100 is positioned in a first orientation. By rotating the device 100 approximately 180 degrees relative to the first orientation, the opposing side of the mechanism 114,124 becomes positioned to engage the fastener. In this flipped orientation, the mechanism 114,124 may be configured to rotate in a second direction when re-engaging the fastener, wherein the second direction is opposite the first direction. In one embodiment, the device 100 is further comprised of at least one indicia 190 such as but not limited to an arrow, a marking, a text, a symbol, etc. that indicates which direction the mechanism 114,124 will rotate when that side of the device 100 is facing upwards toward the user.

In one embodiment, each head 112,122 may be pivotally connected to the body 102 via a pivot point 140. The pivot point 140 may be comprised of but not limited to a hinge, pin joint, or similar articulating structure that permits angular deflection of each head 112,122 relative to the body 102, as seen in FIG. 2. This articulation may enable the device 100 to accommodate non-linear or obstructed working angles during operation.

In one embodiment, the body 102 may be comprised of a rubber grip area 103, which may be formed from an elastomeric or thermoplastic overmolded material. The grip area 103 may enhance ergonomic handling and operator comfort. In one embodiment, the grip area 103 may be further comprised of a texture 104 such as but not limited to a raised pattern comprising ridges, diamonds, stippling, or other high-friction features to increase hand traction during use. In another embodiment, the texture 104 may be integrally formed directly on the surface of the body 102 with no separate grip area 103.

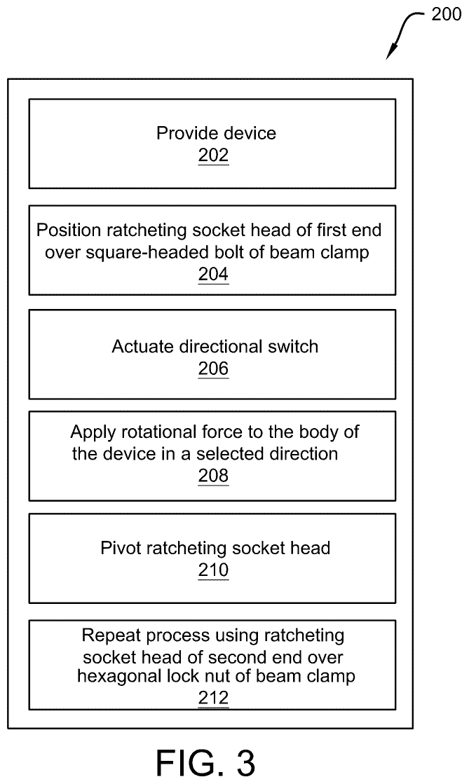

The present invention is also comprised of a method of using 200 the device 100, as seen in FIG. 3. First, a device 100 is provided comprised of a body 102 having a first end 110 with a first ratcheting socket head 112, a second end 120 with a second ratcheting socket head 122, and optionally a grip area 103 on the body 102 [Step 202]. Then, the ratcheting socket head 112 of the first end 110 is positioned over a square-headed adjustment bolt of a beam clamp, wherein the square-profiled cutout 150 of the head 112 engages the flat faces of the square-headed bolt [Step 204]. Then, the directional switch 130 on the respective head 112 or 122 is actuated to select the desired torque direction of the internal mechanism 114 or 124, thereby enabling clockwise or counter-clockwise operation [Step 206]. Next, rotational force is applied to the body 102 in the selected direction, whereby the corresponding ratcheting head 112,122 transfers unidirectional torque to the engaged fastener, allowing adjustment or installation of the beam clamp without tool change [Step 208]. If necessary, the respective ratcheting socket head 112 or 122 is pivoted about its pivot point 140 to allow engagement of fasteners positioned at non-linear or obstructed angles [Step 210]. The entire process (step 204 to step 210) can then be repeated with the ratcheting socket head 122 of the second end 120, wherein the head 122 is positioned over a hexagonal lock nut of the beam clamp and wherein the 12-point socket cutout 160 of the head 122 engages the flat surfaces of the hexagonal nut [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “beam clamp wrench device” and “device” are interchangeable and refer to the beam clamp wrench device 100 of the present invention.

Notwithstanding the foregoing, the beam clamp wrench device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the beam clamp wrench device 100 as shown in the FIGS. are for illustrative purposes only, and that many other sizes and shapes of the beam clamp wrench device 100 are well within the scope of the present disclosure. Although the dimensions of the beam clamp wrench device 100 are important design parameters for user convenience, the beam clamp wrench device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A beam clamp wrench device comprising:
a body having a first end and a second end opposite the first end;
a first ratcheting socket head disposed at the first end, the first ratcheting socket head comprising a square-profiled cutout; and
a second ratcheting socket head disposed at the second end, the second ratcheting socket head comprising a 12-point socket cutout.

2. The beam clamp wrench device of claim 1, wherein the square-profiled cutout comprises four flat interior surfaces arranged at 90-degree intervals.

3. The beam clamp wrench device of claim 1, wherein the square-profiled cutout comprises a radiused corner or a chamfered corner.

4. The beam clamp wrench device of claim 1, wherein the 12-point socket cutout is comprised of a dual-hexagonal configuration.

5. The beam clamp wrench device of claim 1, wherein the first ratcheting socket head attaches to the body via a first pivot point.

6. The beam clamp wrench device of claim 5, wherein the second ratcheting socket head attaches to the body via a second pivot point.

7. The beam clamp wrench device of claim 1 further comprised of a first directional switch that changes the direction of the first ratcheting socket head from clockwise to counterclockwise.

8. The beam clamp wrench device of claim 7 further comprised of a second directional switch that changes the direction of the second ratcheting socket head from clockwise to counterclockwise.

9. A beam clamp wrench device comprising:
a body having a grip area comprised of a texture, first end, and a second end opposite the first end;
a first ratcheting socket head disposed at the first end, wherein the first ratcheting socket head comprising a square-profiled cutout; and
a second ratcheting socket head disposed at the second end, the second ratcheting socket head comprising a 12-point socket cutout.

10. The beam clamp wrench device of claim 1, wherein the square-profiled cutout comprises four flat interior surfaces arranged at 90-degree intervals.

11. The beam clamp wrench device of claim 9, wherein the square-profiled cutout comprises a radiused corner or a chamfered corner.

12. The beam clamp wrench device of claim 9, wherein the 12-point socket cutout is comprised of a dual-hexagonal configuration.

13. The beam clamp wrench device of claim 9, wherein the first ratcheting socket head attaches to the body via a first pivot point.

14. The beam clamp wrench device of claim 13, wherein the second ratcheting socket head attaches to the body via a second pivot point.

15. The beam clamp wrench device of claim 14, wherein the first pivot point and the second pivot point are comprised of a hinge or a pin joint.

16. The beam clamp wrench device of claim 9 further comprised of a first directional switch that changes the direction of the first ratcheting socket head from clockwise to counterclockwise.

17. The beam clamp wrench device of claim 16 further comprised of a second directional switch that changes the direction of the second ratcheting socket head from clockwise to counterclockwise.

18. The beam clamp wrench device of claim 9, wherein the grip area is comprised of a rubber material.

19. The beam clamp wrench device of claim 9, wherein the texture is comprised of a ridge, a diamond, or a stippling.

20. A method of using a beam clamp wrench device, the method comprising the following steps:
providing a beam clamp wrench device comprised of a body having a first end with a first ratcheting socket head and a second end with a second ratcheting socket head;
positioning the first ratcheting socket head over a square-headed bolt of a beam clamp or positioning the second ratcheting socket head over a hexagonal lock nut of the beam clamp;
actuating a directional switch on the first ratcheting socket head or the second ratcheting socket head to select a torque direction of the first ratcheting socket head or the second ratcheting socket head; and
applying a rotational force to the body in a selected direction, thereby transferring a unidirectional torque to the square-headed bolt or the hexagonal lock nut.
